(19) United States
(12) Patent Application Publication
(10) Pub. No.: US 2005/0022846 A1
(43) Pub. Date: Feb. 3, 2005

(54) Contact lens rinsing and placement process

(76) Inventor: Neil John Graham, Long Beach, CA (US)

Correspondence Address: Neil John Graham, 6017 Lido Lane, Long Beach, CA, 90803, US

(21) Appl. No.: 10/629,115

(22) Filed: Jul. 30, 2003

(51) Int. Cl. B08B 3/04

(52) U.S. Cl. 134/22.1; 134/25.1; 134/25.4; 134/26; 134/901

(57) ABSTRACT

The invention involves the process of using a lens placement instrument to hold a contact lens while rinsing visible debris from the lens which resulted from finger contact with the contact lens and to carry the rinsed lens to the eye where it releases the lens, with a puff of air, without further contamination from the fingers. The process increases the initial comfort of the lens on the user's eye, the lens feels like a drop of water on the eye, and increases the comfortable symptom-free wear time of the contact lens.

### FIELD OF THE INVENTION

The invention involves the process of producing a thoroughly rinsed contact lens when placed upon the eye with no intervening hand contact.

### BACKGROUND OF THE INVENTION

The conventional process of placing a contact lens on the eye has been removing the contact lens from the contact lens solution and placing the outside curvature of the contact lens on a tip of a finger, removing some of the contact lens solution from between the contact lens and finger, and seating the lens on the eye wherein the lens is released from the finger and remains seated on the eye. The purpose of the removal of moisture from the finger is to reduce the surface tension between the finger and contact lens sufficiently that the contact lens will remain on the eye. The above procedure has been followed by the contact user as well as the optometrist when placing his patient's lens. However clean the fingers may be, the contact lens will have observable particles on its surface resulting from contact with the fingers. These particles are still present on the contact lens when the lens is seated on the eye. Particles plus the semi-dried outer surface of the lens produce the effect of a foreign object on the eye. Great efforts have been expended by the contact lens industry to produce better sterilizing solutions, but no efforts have addressed the particles and oils which are transferred from fingers to the contact lens just prior to lens placement on the eye.

### SUMMARY OF THE INVENTION

The invention provides a process which allows the contact lens to be free of visible impurities resulting from hand contact with the lens. In a preferred embodiment the contact lens is removed from the contact lens solution, oriented wherein the inner curvature of the contact lens is the eye-contacting surface, gripped at a folded outer edge by a thumb and finger, held vertically with the free edge downward, and dipped in the contact lens solution until the lens is visibly clear. The outer curvature of the free edge area of the lens is then placed on the conical surface of a lens placement instrument and the handheld portion of the lens is then vertically dipped into the lens solution until the contact lens appears clear. The lens is then placed on the eye and the air bulb of the lens placement instrument is squeezed which forces air on the outer curvature of lens and releases the lens on the eyeball. The result is the lens feels like a drop of water on the eyeball, not a foreign object. There is now excess water on the eyeball which is dissipated by holding the upper eyelid open, looking straight ahead, and moving the head back-and-forth and up-and-down. The effect of this process of placing a rinsed and fully wet contact lens on the eye enhances the initial comfort of the lens and increases the symptom-free wear time.

### BRIEF DESCRIPTIONS OF THE DRAWINGS

FIG. 1 is view of the contact lens placement instrument.

FIG. 2 is a view of a contact lens on a finger.

FIG. 3 is a view of the contact lens being handheld in preparation to being dipped into a contact lens solution.

FIG. 4 is a view of the contact lens mounted on the contact lens placement instrument.

FIG. 5 is a view of the contact lens on the instrument being dipped into the contact lens solution.

FIG. 6 is a view of the contact lens being placed on the eye with the contact lens placement instrument.

### DETAILED DESCRIPTION OF THE INVENTION

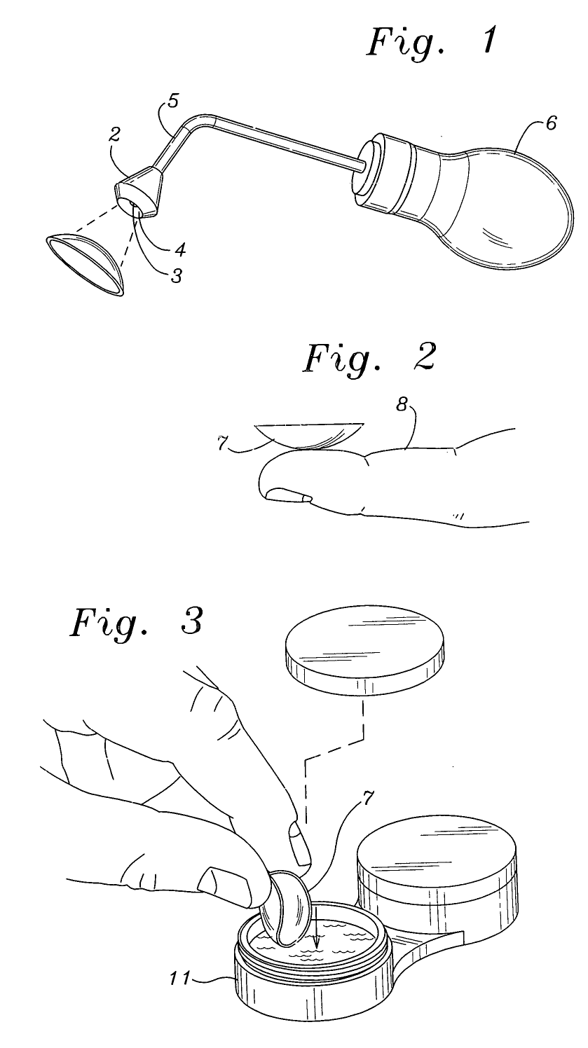

The invention comprises a process of rinsing a contact lens 7 until it is free of visible debris and subsequently placing and releasing the lens on the eye without any intervening finger contact with the lens. In a preferred embodiment contact a lens placement instrument 1 is used, as shown in FIG. 1, comprising a contact lens holder 2 with a conical surface 4 which receives the contact lens 7. A hollow tube 5 with an air bulb 6 attached to an opposing end is attached to the contact lens holder 2. The air bulb 6 provides a puff of air to an air hole 3 in the comical surface 4 which releases the contact lens 7 after the lens 7 is seated upon the eye. The contact lens placement instrument 1 is claimed in pending patent application Ser. No. 10/405,364.

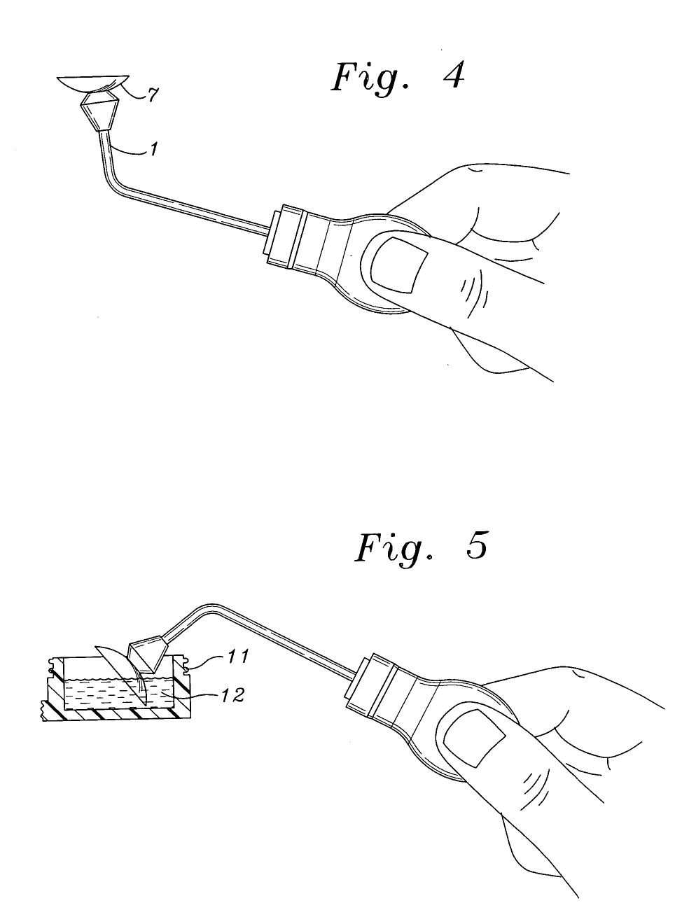

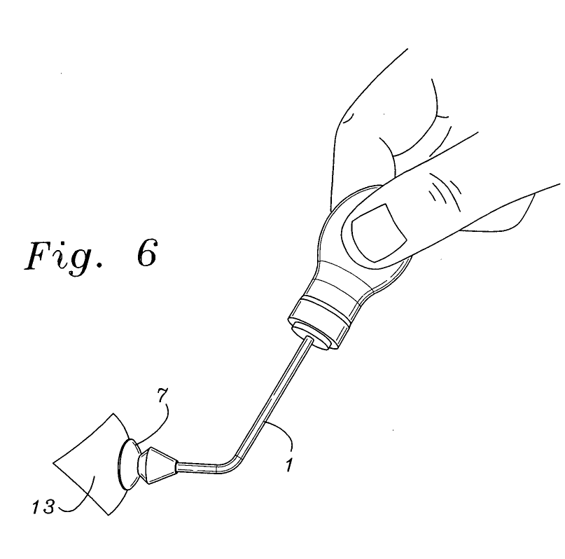

The contact lens 7 is removed from the lens case and is correctly oriented for placement, as in FIG. 2, on the user's finger 8. The contact lens 7 is then grasped on one side between the thumb and index finger, as in FIG. 3, and is dipped into the lens solution, repeatedly, if necessary, until the lens 7 is visibly clear. The outer curvature of the dipped portion of the contact lens 7, as in FIG. 4, is then placed upon the conical surface 4 of the contact lens placement instrument 1. The outer conical surface 4 is curved to match the outer curvature of the contact lens 7 which, in combination with the surface tension of the contact lens solution, enhances the adhesion of the contact lens to the contact lens placement instrument 1. Using the air bulb 6 a slight amount of vacuum can be applied to the contact lens 7 to enhance the adhesion. In FIG. 5 the portion of the contact lens 7 which had been held with the users fingers is dipped, repeatedly, if necessary, into the contact lens solution 12 until the lens 7 appears clear. Using the contact lens placement instrument 1 the contact lens 7 is carried to the eye 13, as in FIG. 6, and is seated and released by squeezing the air bulb 6 which puffs air on the outer curvature of the contact lens 7.

In another embodiment of the invention a contact lens placement instrument 1 may be used which does not contain the air bulb 6. The contact lens holder 2 may be made from silicone, metal, plastic, polyurethane, and other materials which would be relatively inert and can be shaped to hold the contact lens 7 by its outer curvature. The instrument may be curved the shape of the tip of a finger.

The object of the invention is not to limit the method to a specific tool, but to include equivalent methods and instruments which facilitate placing a contact lens 7 on the eye without intervening finger contact with the contact lens.

1. A process of cleaning and placing a contact lens on the eye comprising:
gripping the contact lens, the lens having an inner and outer curvature and a circular edge, wherein a small portion of the circular edge is gripped leaving a free opposing edge;
dipping the opposing free edge portion of the contact lens vertically into a contact lens solution, repeatedly, if necessary, until the contact lens appears visibly clear;
placing the outer curvature of the opposing free edge portion of the contact lens on an instrument leaving the gripped side free;
dipping the gripped side of the contact lens into the contact lens solution, repeatedly, if necessary, until the contact lens appears visibly clear; and
carrying the contact lens to the eye with the instrument wherein the inner curvature of the contact lens is seated on the eye.

2. A process of cleaning and placing a contact lens on the eye as in claim 1 wherein the contact lens is gripped at the edge by folding its outer curvature between the user's thumb and finger.

3. A process of cleaning and placing a contact lens on the eye as in claim 1 wherein the contact lens free opposing edge side hangs downward and vertical while dipping the lens into the contact lens solution.

4. A process of cleaning and placing a contact lens on the eye as in claim 1 wherein the contact lens gripped side hangs downward and vertical while dipping the lens into the contact lens solution.

5. A process of cleaning and placing a contact lens on the eye as in claim 1 wherein the instrument is a contact lens placement instrument comprising a contact lens holder with a conical surface for seating the outer curvature of the contact lens, a connecting hollow tube with first and second ends, the first end connected to the lens holder, and an air bulb connected to the second end of the hollow tube.

6. A process of cleaning and placing a contact lens on the eye as in claim 1 wherein the instrument is a contact lens placement instrument wherein the contact lens when seated in the eye is released with a puff of air from the contact lens placement instrument.

7. A process of cleaning and placing a contact lens on the eye comprising:
gripping the contact lens, the lens having an inner and outer curvature and a circular edge, wherein a small portion of the circular edge is gripped between a thumb and finger leaving a free opposing edge;
dipping the opposing free edge portion of the contact lens vertically into a contact lens solution, repeatedly, if necessary, until the contact lens appears visibly clear;
placing the outer curvature of the opposing free edge portion of the contact lens on an instrument leaving the gripped side free;
dipping the gripped side of the contact lens into the contact lens solution, repeatedly, if necessary, until the contact lens appears visibly clear; and
carrying the contact lens to the eye with the instrument wherein the inner curvature of the contact lens is seated on the eye.

8. A process of cleaning and placing a contact lens on the eye as in claim 7 wherein the contact lens opposing free edge portion hangs downwards vertically while dipping the lens into the contact lens solution.

9. A process of cleaning and placing a contact lens on the eye as in claim 7 wherein the gripped edge portion hangs downwards vertically while dipping the lens into the contact lens solution.

10. A process of cleaning and placing a contact lens on the eye as in claim 7 wherein the instrument is a contact lens placement instrument comprising a contact lens holder with a conical surface for seating the outer curvature of the contact lens, a connecting hollow tube with first and second ends, the first end connected to the lens holder, and an air bulb connected to the second end of the hollow tube.

11. A process of cleaning and placing a contact lens on the eye as in claim 7 wherein the instrument is a contact lens placement instrument wherein the contact lens when seated on the eye is released with a puff of air from the contact lens placement instrument.

12. A process of cleaning and placing a contact lens on the eye comprising:
gripping the contact lens, the lens having an inner and outer curvature and a circular edge, wherein a small portion of the circular edge is gripped leaving a free opposing edge;
dipping the opposing free edge portion of the contact lens vertically into a contact lens solution, repeatedly, if necessary, until the contact lens appears visibly clear;
placing the outer curvature of the opposing free side portion of the contact lens on the instrument leaving a gripped side free portion, wherein the outer curvature of the contact lens rests freely on the instrument, the instrument is a contact lens placement instrument comprising a contact lens holder with a conical surface for seating the outer curvature of the contact lens, a connecting hollow tube with first and second ends, the first end connected to the lens holder, an air bulb connected to the second end of the hollow tube;
dipping the second free side of the contact lens into the contact lens solution, repeatedly, if necessary, until the contact lens appears visibly clear; and
carrying the contact lens to the eye wherein the inner curvature of the contact lens is seated on the eye.

13. A process of cleaning and placing a contact lens on the eye as in claim 12 wherein the contact lens is gripped at an edge by folding its outer curvature between the user's thumb and finger.

14. A process of cleaning and placing a contact lens on the eye as in claim 12 wherein the contact lens gripped side portion hangs downwards and vertically while dipping the lens into the contact lens solution.

15. A process of cleaning and placing a contact lens on the eye as in claim 12 wherein the contact lens gripped side portion hangs downward and vertical while dipping the lens into the contact lens solution.

16. A process of cleaning and placing a contact lens on the eye as in claim 12 wherein the instrument is a contact lens placement instrument wherein the contact lens when seated in the eye is released with a puff of air from the contact lens placement instrument to the outer surface of the contact lens.

17. A process of cleaning and placing a contact lens on the eye comprising:
gripping the contact lens, the lens having an inner and outer curvature and a circular edge, wherein a small portion of the circular edge is gripped leaving a free opposing edge;
dipping the opposing free edge portion of the contact lens vertically into a contact lens solution, repeatedly, if necessary, until the contact lens appears visibly clear;
placing the outer curvature of the opposing free edge portion of the contact lens on an instrument leaving the gripped side free;
dipping the gripped side of the contact lens into the contact lens solution, repeatedly, if necessary, until the contact lens appears visibly clear;
carrying the contact lens to the eye with the instrument wherein the inner curvature of the contact lens is seated on the eye; and
releasing the contact lens with a puff of air directed at the outer curvature of the contact lens.

18. A process of cleaning and placing a contact lens on the eye as in claim 17 wherein the contact lens gripped at an edge by folding its outer curvature between the user's thumb and finger.

19. A process of cleaning and placing a contact lens on the eye as in claim 17 wherein the contact lens opposing free edge portion hangs downwards and vertically while dipping the lens into the contact lens solution.

20. A process of cleaning and placing a contact lens on the eye as in claim 17 wherein the contact lens gripped side portion hangs downwards and vertical while dipping the lens into the contact lens solution.

21. A process of cleaning and placing a contact lens on the eye as in claim 17 wherein the instrument is a contact lens placement instrument comprising a contact lens holder with a conical surface for seating the outer curvature of the contact lens, a connecting hollow tube with first and second ends, the first end connected to the lens holder, and an air bulb connected to the second end of the hollow tube.
